(19) United States
(12) Patent Application Publication
(10) Pub. No.: US 2025/0057090 A1
(43) Pub. Date: Feb. 20, 2025

(54) USE OF A TUBULAR STRUCTURE TO GROW PLANTS AND CORRESPONDING METHOD

(71) Applicant: René BRUNONE, SAINT-MARCEL (FR)

(72) Inventor: René BRUNONE, SAINT-MARCEL (FR)

(21) Appl. No.: 18/807,236

(22) Filed: Aug. 16, 2024

(30) Foreign Application Priority Data
Aug. 17, 2023 (FR) 2308746

(51) Int. Cl. A01G 9/02

(52) U.S. Cl. CPC A01G 9/023

(57) ABSTRACT

A method of using a tubular structure for cultivating plants, the tubular structure including a base tubular wall having a central axis and having first and second closed-contour edges at first and second opposed axial ends, the first and second axial ends being open over at least 50% of the respective surfaces thereof. The first edge is placed on a ground. The base tubular wall is filled with a growth medium, such as potting soil, communicating with the soil through the first open end. The plants are planted in the growth medium.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to the cultivation of plants in planters or pots.

### BACKGROUND

It is known to use pots in which to grow plants. The plants have to be watered and nourished with fertilizer.

The maintenance of such plants is thus demanding.

### SUMMARY

In such context, the present disclosure aims to propose a method for the cultivation of plants that generates less requirements.

To this end, the present disclosure relates to the use of a tubular structure for cultivating plants, the tubular structure comprising a base tubular wall having a central axis and having first and second closed-contour edges at opposite first and second axial ends, said first and second axial ends being open over at least 50% of the respective surfaces thereof;
the first edge is placed on a ground;
the base tubular wall being filled with a growth medium such as potting soil, communicating with the soil through the first open end;
plants being planted in the growth medium.

Because the tubular wall is filled with a growth medium communicating with the soil through the first open end, exchanges occur between the soil and the growth medium. In particular, moisture can rise from the ground inside the tubular wall. Earthworms can circulate between the soil and the growth medium.

Thereof contributes to reducing the requirements associated with the cultivation of plants planted in the tubular structure.

The system can further have one or a plurality of the following features, considered individually or in all technically possible combinations:
The first end is open over at least 90% of the surface thereof, preferably over 100% of the surface thereof.
The base tubular wall has openings, cups protruding radially outwards from the base tubular wall and being placed immediately offset toward the first edge with respect to the openings.
The cups are filled with the growth medium, plants being planted in the growth medium filling the cups.
The tubular structure comprises at least one second tubular wall coaxial with the base tubular wall, having first and second closed-contour edges at first and second opposed axial ends, said first and second axial ends being open over at least 50% of the respective surfaces thereof, the first edge being laid on the second edge of the base tubular wall.
The base tubular wall and the second tubular wall are locked in position relative to each other by mating reliefs formed on the second edge of the base tubular wall and on the first edge of the second tubular wall.
The base tubular wall and the second tubular wall are locked in position relative to each other by a pin engaged in rings rigidly attached to the base tubular wall and to the second tubular wall.
The basic tubular wall is made of terracotta.

According to a second aspect, the present disclosure relates to a method of growing plants, the method comprising the following steps:
obtaining a tubular structure comprising a base tubular wall having a central axis and having first and second closed-contour edges at opposite first and second axial ends, said first and second axial ends being open over at least 50% of the respective surfaces thereof;
placing the first edge on a ground;
filling the base tubular wall with a growing medium such as potting soil, communicating with the soil through the first open end;
planting plants in the growing medium.

### BRIEF DESCRIPTION OF THE DRAWINGS

Other features and advantages of the present disclosure will be clear from the description thereof which is given below as an example, but in no way limited to, with reference to the enclosed Figures, among which:

FIG. 1 is a side view of the tubular structure used in the present disclosure; and

FIG. 2 is a top view of the tubular structure shown in FIG. 1.

### DETAILED DESCRIPTION

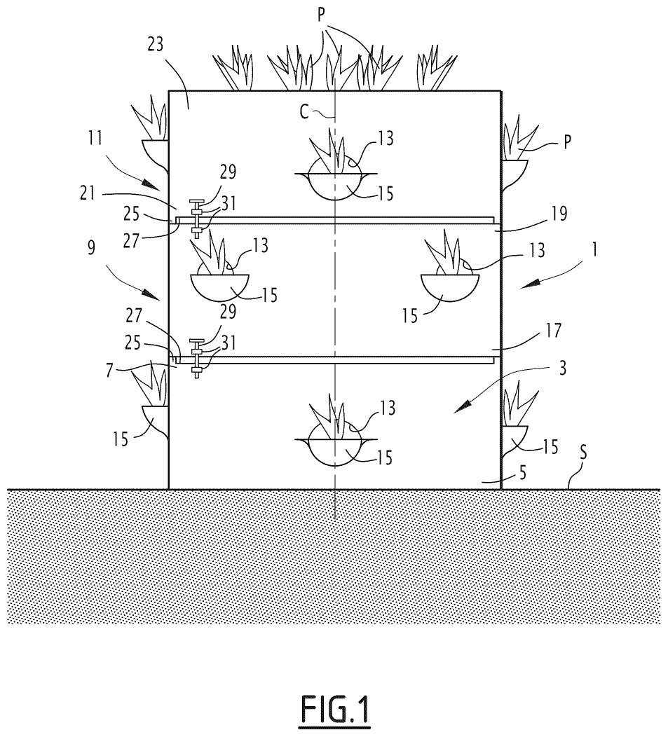

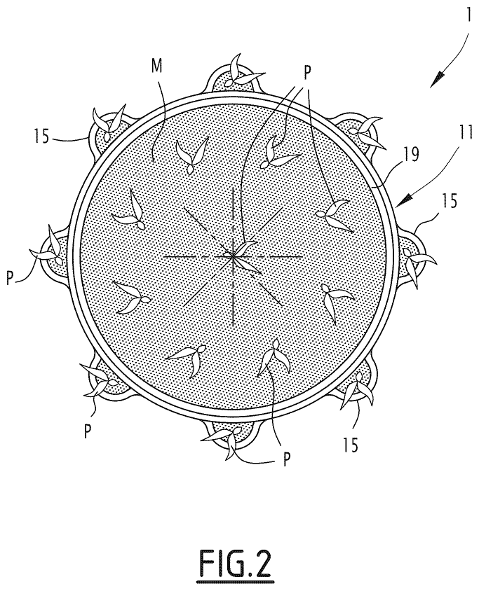

The tubular structure 1 shown in FIGS. 1 and 2 is used to grow plants.

The plants are e.g. flowers, shrubs, or any other type of plant suitable for being grown in a pot.

The tubular structure 1 comprises a base tubular wall 3 having a central axis C and having first and closed-contour second edges 5, 7 at first and second opposite axial ends.

Advantageously, the tubular structure 1 comprises at least one second tubular wall 9 coaxial with the base tubular wall 3.

The second tubular wall 9 is placed on the base tubular wall 3.

In the example shown, the tubular structure 1 has a third tubular wall 11 coaxial with the base tubular wall 3.

The third tubular wall 11 is placed on the second tubular wall 9.

In a variant (not shown), the tubular structure 1 comprises only the base tubular wall, no other tubular wall being placed on the base tubular wall.

In another variant (not shown), the tubular structure 1 comprises only the base tubular wall and the second tubular wall, without a third tubular wall.

In yet another variant (not shown), the tubular structure 1 further comprises one or a plurality of other tubular walls placed on the second tubular wall.

The first and second axial ends of the base tubular wall 3 are open over at least 50% of the respective surfaces thereof.

The first end, delimited by the first closed-contour edge 5, is open over at least 90% of the surface thereof, and is preferably open over 100% of the surface thereof.

Similarly, the second end, delimited by the second closed-contour edge 7, is open over at least 90% of the surface thereof, and preferably more over 100% of the surface thereof.

The base tubular wall is cylindrical. Perpendicular to the central axis C, same has a circular cross-section, constant throughout the axial height thereof.

Same has e.g. a diameter of 500 mm and an axial height of 200 mm.

The first edge 5 of the tubular base structure 3 is placed on the ground S.

The central axis C is perpendicular to the ground S.

In the present description, the terms top, bottom, upper, lower refer to a direction perpendicular to the ground S, corresponding to the central axis C of the base tubular wall when the latter is placed on the ground S.

The base tubular wall 3 has openings 13. The openings 13 are cut out in the base tubular wall and put the internal volume of the base tubular wall 3 in communication with the outside.

Same are distributed throughout the periphery of the base tubular wall 3.

For example, the openings 13 are located at 90° from each other, around the central axis C.

The base tubular wall 3 further includes cups 15 protruding radially outwards from the base tubular wall 3.

The cups 15 protrude from the outer surface of the base tubular wall 3. Same are placed immediately offset toward the first closed-contour edge 5 with respect to the openings 13.

In other words, the cups 15 are placed under the openings 13.

Each cup 15 then has a concave side turned upwards, i.e. toward the opening 13, and a convex side turned downwards, i.e. toward the ground S.

Each cup 15 is attached to the external surface of the base tubular wall 3 along a line having a general U-shape, which follows the lower edge of the opening 13.

Thereby, the lower part of the opening 13 opens directly into the cup 15, and the upper part of the opening 13 is situated above the cup 15.

The second upper tubular wall 9 is of the same type as the base tubular wall 3. Same has the same dimensions as the first upper tubular wall and the base tubular wall, in particular the same diameter and the same height.

Same also has first and second closed-contour edges 17, 19 at opposite first and second axial ends.

The first and second axial ends are open over at least 50% of the respective surfaces thereof, preferably over at least 90% of the respective surfaces thereof, and more preferably over 100% of the respective surfaces thereof.

The upper tubular wall 9 includes openings 13 and cups 15 of the same type as same described with reference to the base tubular wall 3.

The third intermediate tubular wall 11 is of the same type as the base tubular wall 3.

Same has the same dimensions as the second tubular wall 9 and the base tubular wall 3, in particular the same diameter and the same height.

Same also has first and second closed-contour edges 21, 23 at the opposite axial ends thereof. The first and second axial ends are open over at least 50% of the respective surfaces thereof, preferably at least 90% and else preferably 100%.

The third tubular wall 11 includes openings 13 and cups 15 of the same type as same described with reference to the base tubular wall 3.

The first closed-contour edge 17 of the second tubular wall 9 is placed on the second closed-contour edge 7 of the base tubular wall 3.

The first closed-contour edge 17 of the second tubular wall 9 exactly follows the second closed-contour edge 7 of the base tubular wall 3.

Similarly, the first edge 21 of the third tubular wall 11 is placed on the second edge 19 of the second tubular wall 9.

The first edge 21 follows exactly the second edge 19 of the second tubular wall 9.

Together, the base tubular wall 3, the second tubular wall 9 and the third tubular wall 11 form a hollow cylindrical container without any internal partition.

The tubular structure 1 includes means for locking the base tubular wall and the second tubular wall in position with respect to each other.

According to a first variant of embodiment, the means are mating reliefs formed on the second edge 7 of the base tubular wall 3 and on the first edge 17 of the second tubular wall 9. In the example shown, the second edge 7 has a closed-contour rib 25. The first edge 17 has another closed-contour rib 27 arranged radially inside the rib 25.

According to another variant of embodiment, the means for locking in position comprise a pin 29 engaged in rings 31 rigidly attached to the base tubular wall 3 and to the second tubular wall 9.

The second tubular wall 9 and the third tubular wall 11 are locked in position with respect to each other by the same means.

Typically, the base tubular wall is made of terracotta.

The second tubular wall and/or the third tubular wall are made of the same material.

As indicated hereinabove, the tubular structure 1 is used to cultivate plants P by placing the first edge 5 of the base tubular structure 3 on the soil S. The base tubular wall 3 is then filled with a growth medium M such as a potting soil.

The growth medium M communicates with the soil through the first open end of the base tubular wall 3. Plants P are planted in the growth medium M.

When the tubular structure 1 comprises one or a plurality of other tubular walls placed on the base tubular wall, e.g. the second tubular wall 9 and the third tubular wall 11, the or each other tubular wall is also filled with the growth medium M.

The cups 15 are also filled with the growth medium M, the latter communicating with the growth medium M filling the internal volume of the tubular wall through the openings 13.

The plants P are planted in the growth medium M contained in the cups 15. Same are also planted at the second open end of the uppermost tubular wall.

The second end belongs to the base tubular wall when the tubular structure has no other tubular wall.

What is claimed is:

1. A method of using a tubular structure for growing plants,
wherein the tubular structure comprises a base tubular wall having a central axis and having first and second closed-contour edges at first and second opposed axial ends, said first and second axial ends are open over at least 50% of the respective surfaces thereof,
wherein the first closed-contour edge is placed on a ground, and
wherein the base tubular wall is filled with a growing medium communicating with a soil through the first open end, and the plants are planted in the growing medium.

2. The method according to claim 1, wherein the first end is open over at least 90% of the surface thereof.

3. The method according to claim 1, wherein the base tubular wall has openings, cups protruding radially outwardly from the base tubular wall and being located immediately offset toward the first edge with respect to the openings.

4. The method according to claim 3, wherein the cups are filled with a growth medium, the plants are planted in the growth medium filling the cups.

5. The method according to claim 1, wherein the tubular structure comprises at least one second tubular wall coaxial with the base tubular wall, having first and second closed-contour edges at first and second opposed axial ends, the first and second axial ends being open over at least 50% of the respective surfaces thereof, the first edge is placed on the second closed-contour edge of the base tubular wall.

6. The method according to claim 5, wherein the base tubular wall and said at least one second tubular wall are locked in position relative to each other by mating reliefs, formed on the second closed-contour edge of the base tubular wall and on the first edge of said at least one second tubular wall.

7. The method according to claim 5, wherein the base tubular wall and said at least one second tubular wall are locked in position relative to each other by a pin engaged in rings rigidly attached to the base tubular wall and to said at least one second tubular wall.

8. The method according to claim 1, wherein the base tubular wall is made of terracotta.

9. The method according to claim 1, wherein the growing medium is a potting soil.

10. The method according to claim 1, wherein the first end is open over 100% of the surface thereof.

11. A method of growing plants, comprising:
obtaining a tubular structure comprising a base tubular wall having a central axis and having first and second closed-contour edges at first and second opposed axial ends, said first and second axial ends being open over at least 50% of the respective surfaces thereof;
placing the first closed-contour edge on a ground;
filling the base tubular wall with a growing medium communicating with a soil through the first open end; and
planting the plants in the growing medium.

12. The method according to claim 11, wherein the growing medium is a potting soil.
